(19) United States
(12) Patent Application Publication
(10) Pub. No.: US 2015/0121220 A1
(43) Pub. Date: Apr. 30, 2015

(54) TERMINAL, METHOD FOR DISPLAYING SCREEN THEREOF, AND COMPUTER READABLE RECORDING MEDIUM

(71) Applicant: SAMSUNG ELECTRONICS CO., LTD., Suwon-si (KR)

(72) Inventors: Jung-kun LEE, Seoul (KR); Yong-ho KIM, Seoul (KR); Jang-woo LEE, Seoul (KR); Jung-won LEE, Seoul (KR); Hye-won LEE, Seoul (KR)

(73) Assignee: SAMSUNG ELECTRONICS CO., LTD., Suwon-si (KR)

(21) Appl. No.: 14/523,222

(22) Filed: Oct. 24, 2014

Related U.S. Application Data
(60) Provisional application No. 61/895,098, filed on Oct. 24, 2013.

(30) Foreign Application Priority Data
Oct. 15, 2014 (KR) 10-2014-0138889

(51) Int. Cl. G06F 3/0484; G06F 3/0482; H04L 29/08

(52) U.S. Cl. CPC G06F 3/04842; H04L 67/10; G06F 3/0482
USPC 715/716

(57) ABSTRACT

A terminal, a method for displaying a screen of a terminal, and a computer readable recording medium are provided. The method includes displaying a music list including a music play-back item of each of one or more contacts, the music play-back item generated based on contact information of the one or more contacts stored in the terminal and a registration status of the one or more contacts to a music service and displaying a play-back screen that provides a music service corresponding to a music play-back item of a contact according to a user selection from among the music play-back item of each of the one or more contacts.

### CROSS-REFERENCE TO RELATED APPLICATIONS

This application claims the benefit of U.S. Provisional Application No. 61/895,098 filed on Oct. 24, 2013, in the United States Patent and Trademark Office and priority from Korean Patent Application No. 10-2014-0138889 filed on Oct. 15, 2014, in the Korean Intellectual Property Office, the entire disclosures of which are incorporated herein by reference in their entireties.

### BACKGROUND

1. Field

Apparatuses and methods consistent with the exemplary embodiments relate to a terminal, a method for displaying a screen thereof, and a computer readable recording medium; and more particularly, to a terminal which enables a user to easily share a music item with friends through a simple and convenient user interface when using a music service, a method for displaying a screen thereof, and a computer readable recording medium.

2. Description of Related Art

Listening to music is one of the most common and universal hobbies. A user is able to enjoy music anytime and anywhere by using an MP3 player even though the user does not have spare time for listening to music. In addition, with the development of a smart digital era, a sound source market is growing. As well as music itself, there are many industry items related to music. That is, music may be applied to many different activities, for example, such as a music game, an entertainment program or a drama about music, etc. Music is an attractive subject having universality and applicability.

In fact, several ‘social music services’ have appeared recently. With the development of a music market, genres have been segmented and musicians have been branded. There are various and numerous music tastes. Thus, it is not easy to meet people having the same music taste. However, once people with similar tastes in music meet, they are able to talk about favorite musicians, recommend favorite music to each other, or go to a concert together. ‘Social music’ enables people having the same music taste to meet or to communicate with each other. In other words, an era in which people communicate with each other through music has arrived.

However, in the conventional social music services, a user must perform many operations by using a social network service in order to share their own music items with friends or to see their friends' music items while using a music service.

In addition, the user must edit their play-back list one by one and make the list public to other users, in order for the other users to see the play-back list through a recommendation operation and a retrieving operation.

Further, the user was unable to quickly see their music taste and a music taste of another user. Such necessity has been raised based on the characteristics of social music.

### SUMMARY

One or more exemplary embodiments provide a terminal which enables a user to easily share music with friends through a simple and convenient user interface when using a music service, a method for displaying a screen thereof, and a computer readable recording medium.

In an aspect according to an exemplary embodiment, there is provided a method for displaying a screen of a terminal, the method including: displaying a music list including a music play-back item of each of one or more contacts, the music play-back item generated based on contact information of the one or more contacts stored in the terminal and a registration status of the one or more contacts with a music service; and displaying a play-back screen that provides a music service corresponding to a music play-back item of a contact according to a user selection from among the music play-back item of each of the one or more contacts.

The displaying the music list may include displaying a notification area that provides information on a popular music item or a new music item included in the music list.

The displaying the music list may include displaying a first button for each of the one or more contacts, which shows an on status or an off status of each of the one or more contacts connected online, and in response to a selection of the first button while a contact is in an on status, providing a listening service of shared music items between the user and the contact.

The displaying the music list may further include displaying a second button for each of the one or more contacts, which, when selected, plays back a last music item to which the contact in an off status last listened.

The displaying the music list include displaying a link area for moving to a music home screen of the contact.

The displaying the music list may include displaying a first menu for setting at least one of a closeness relationship with the contact, a similarity in taste with respect to the music items, and a similarity in age of the music items, to determine a display order of the music list.

The displaying the music list may further include displaying a second menu including a my room menu item for moving to a music home screen of the user and a music room menu item for forming a music group with the contacts.

The second menu may further include a play-back option menu item for setting an option of playing back the music items in the music list of the contacts, and wherein the play-back option menu item may include at least one of an option of playing back the music items of each contact in a sequential order, in a reverse sequential manner, or in a shuffling manner; or at least one of an option of playing back the music items of the entire contacts one by one in a sequential order, in a reverse sequential manner, or in a shuffling manner.

The music list may be changed according to a predetermined time cycle.

In an aspect according to another exemplary embodiment, there is provided a terminal including: a display configured to display a music list including a music play-back item of each of one or more contacts, the music play-back item generated based on contact information of the one or more contacts stored in the terminal and a registration status of the one or more contacts with a music service; and a controller configured to control the display to display a play-back screen that provides a music service corresponding to a music play-back item of a contact according to a user selection from among the music play-back item of each of the one or more contacts.

The display may be further configured to display a notification area that provides information on a popular music item or a new music item included in the music list.

The display may be further configured to display a first button for each of the one or more contacts, which shows an on status or an off status of each of the one or more contacts connected online on the music play-back item of the music list, and in response to selection of the first button while a contact is in an on status, provide a listening service of shared music items between the user and the contact.

The display may be further configured to display a second button for each of the one or more contacts, which, when selected, plays back a last music item to which the contact in an off status last listened.

The display may be further configured to display a link area for moving to a music home screen of the contact on the music play-back item of the music list.

The display may be further configured to display a first menu for setting at least one of a closeness relationship with the contact, a similarity in taste with respect to the music items, and a similarity in age of the music items, to determine a display order of the music list.

The display may be further configured to display a second menu including a my room menu item for moving to a music home screen of the user and a music room menu item for forming a music group with the contacts.

The second menu may further include a play-back option menu item for setting an option of playing back the music items in the music list of the contacts, and wherein the play-back option menu item may include at least one of an option of playing back the music items of each contact in a sequential order, in a reverse sequential manner, or in a shuffling manner; or at least one of an option of playing back the music items of the entire contacts one by one in a sequential order, in a reverse sequential manner, or in a shuffling manner.

The music list may be changed according to a predetermined cycle.

In an aspect according to another exemplary embodiment, there is provided a non-transitory computer readable recording medium including a program for executing a method for displaying a screen of a terminal, the method including: displaying a music list including a music play-back item of each of one or more contacts, the music play-back item generated based on contact information of the one or more contacts stored in the terminal and a registration status of the one or more contacts with a music service; and displaying a play-back screen that provides a music service corresponding to a music play-back item of a contact according to a user selection from among the music play-back of each of the one or more contacts.

The displaying the music list may include displaying a notification area that provides information on a popular music item or a new music item included in the music list of the.

In an aspect according to another exemplary embodiment, there is provided a method of sharing music, the method including: displaying a music list on a terminal screen, wherein the music list includes a first music item associated with a first contact and a second music item associated with a second contact; displaying a first button for reproducing the first music item associated with the first contact and a second button for reproducing the second music item associated with the second contact; and playing one of the first music item and the second music item associated with one of the first contact and the second contact, in response to a user of the terminal selecting one of the first button and the second button while the one of the first contact and the second contact is in a logged on status.

The method may further include linking to a home page of one of the first contact and the second contact by pressing a link area of one of the first music item and the second music item.

The playing may include: playing music that the one of the first contact and the second contact is currently reproducing if the one of the first contact and the second contact is in a logged on status; and playing music last listened to by the one of the first contact and the second contact if the one of the first contact and the second contact is in a logged off status.

The method may further include displaying most popular songs of the music list, in a notification area of the screen.

According to one or more exemplary embodiments, a convenient user interface for multilateral music sharing may be provided.

### BRIEF DESCRIPTION OF THE DRAWINGS

The above and/or other aspects will be more apparent by describing certain exemplary embodiments with reference to the accompanying drawings, in which:

FIG. 1 is a diagram illustrating a music service system according to an exemplary embodiment;

FIG. 2 is a schematic view illustrating the service of FIG. 1;

FIG. 3 is a block diagram illustrating an example of a structure of a first terminal illustrated in FIG. 1;

FIG. 4 is a block diagram illustrating an example of another structure of the first terminal illustrated in FIG. 1;

FIG. 5 is a diagram illustrating operations of a music service according to an exemplary embodiment;

FIG. 6 is a flowchart illustrating an operating process of the first terminal illustrated in FIG. 1;

FIG. 7 is a diagram illustrating a structure of a screen;

FIG. 8 is a diagram illustrating an example of a music list screen;

FIG. 9 is a diagram illustrating a screen which is displayed in response to selection of a first menu in a screen of FIG. 8;

FIG. 10 is a diagram illustrating a “my room” screen which is displayed in response to selection of a “my home” item in the first menu of FIG. 8;

FIG. 11 is a diagram illustrating a music room screen which is displayed in response to selection of a music room item in the first menu of FIG. 8;

FIG. 12 is a diagram illustrating a screen which is displayed in response to selection of a second menu in the screen of FIG. 8;

FIG. 13 is a diagram illustrating a friend home screen which is displayed in response to selection of a link area of FIG. 8;

FIG. 14 is a diagram illustrating a play-back screen which is displayed in response to a user music selection;

FIG. 15 is a diagram illustrating a play-back screen which is displayed in response to selection of a first button or a second button of FIG. 8;

FIG. 16 is a diagram illustrating a music history of users; and

FIG. 17 is a diagram illustrating various play-back options for playing back songs in a music list.

### DETAILED DESCRIPTION

Exemplary embodiments are described in greater detail below with reference to the accompanying drawings.

In the following description, like drawing reference numerals are used for like elements, even in different drawings. Unless specifically noted otherwise, expressions such as “at least one of,” when preceding a list of elements, modify the entire list of elements and do not modify the individual elements of the list. The matters defined in the description, such as detailed construction and elements, are provided to assist in a comprehensive understanding of exemplary embodiments. However, exemplary embodiments can be practiced without those specifically defined matters. Also, well-known functions or constructions are not necessarily described in detail because they would obscure the application with unnecessary detail.

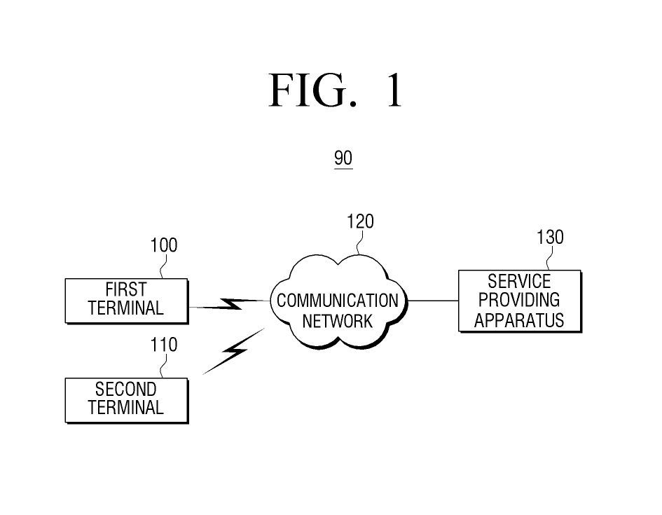

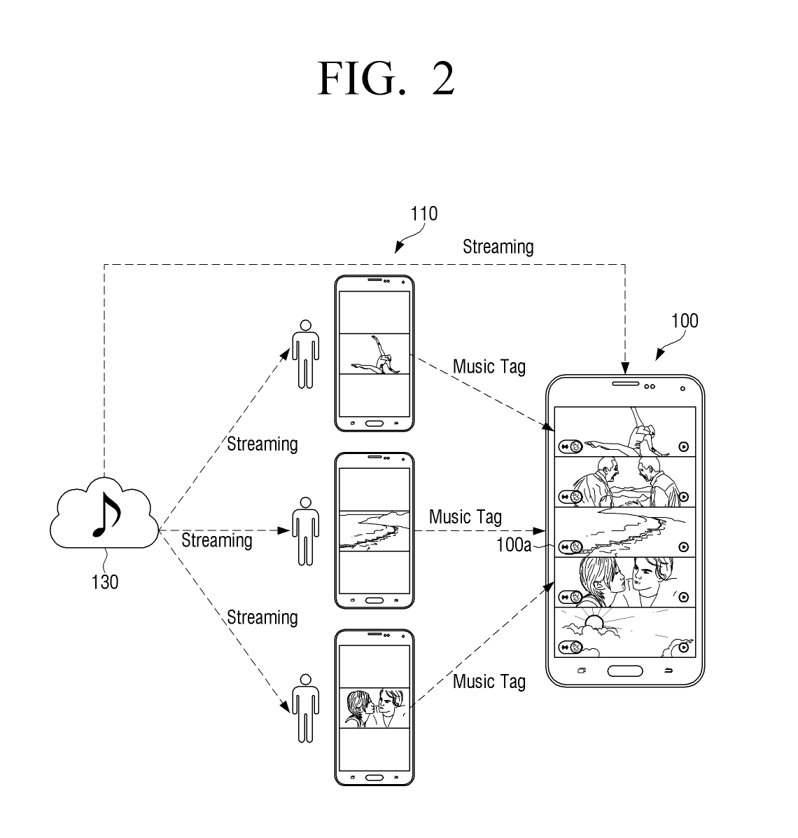

FIG. 1 is a diagram illustrating a music service system according to an exemplary embodiment, and FIG. 2 is a schematic view illustrating the service of FIG. 1.

As shown in FIG. 1, a music service system 90 according to an exemplary embodiment includes at least one of a first terminal 100, a second terminal 110, a communication network 120, and a service providing apparatus 130.

In this exemplary embodiment, it is described that the music service system 90 includes all of the components, for a better understanding of the present disclosure.

The first terminal 100 or the second terminal 110 may include a mobile phone including a smart phone, a Portable Multimedia Player (PMP), an MP3 player, a laptop computer, a wearable device, and the like which enable a user to use a social music service and may further include a TV. When the first terminal 100 is a user's own terminal, the second terminal 110 may be a terminal of another user included in a contact list of the user, for example, a friend. For example, in response to user information of the second terminal 110 being stored in contact information of the first terminal 100, and both of the first terminal 100 and the second terminal 110 being registered in a particular music service, the first terminal 100 may share a music item with the second terminal 110.

For example, in response to a user of the first terminal 100 selecting an icon of an application displayed on a screen in order to use a music service, the first terminal 100 connects to the service providing apparatus 130 and is provided with a service. Accordingly, the first terminal 100 shows a music play-back status of a user of the second terminal 110 as a first screen (or a main screen). The music play-back status may be updated on a predetermined time cycle. That is, with respect to users who registered with the music service among users included in the contact information of the first terminal 100, the first terminal 100 operates with the service providing apparatus 130 so that the users are able to see the music play-back status in real time.

As shown in FIG. 2, the first terminal 100 displays the music play-back status of the users based on the contact information and the service registration status in the form of a music list 100a. In the music list 100a, a column, that is, each of the music items acts as a music station of each user included in the contact information. Each of the music items shows a music play-back status of each user, and each of the music items includes a first button, that is, a button which shows whether a user is currently logged on to the music service. In addition, each of the music items also includes a second button, that is, a play-back button which enables each user to listen to a music item that the user listened to last even when the user is not logged on to the music service. Further, each of the music items includes a link area for going to a home screen area of each user. In addition, on top of the music list 100a which is updated and displayed in real time, the first terminal 100 may display in a notification area the most popular song or a newly appeared song out of the music lists of friends.

The user of the first terminal 100 may provide the service providing apparatus 130 with their own user information. For example, the user may provide an apparatus identification (ID) and information, such as contact information stored in the first terminal 100 when the user registers in a music service. In addition, in response to updating the contact information, the first terminal 100 may periodically provide the service providing apparatus 130 with the updated information. Accordingly, the service providing apparatus 130 may determine whether the user is registered in the music service based on the updated contact information.

The second terminal 110 may be a terminal of a friend of the user of the first terminal 100. The second terminal 110 may provide the service providing apparatus 130 with information on the music play-back status in real time or periodically, depending upon a registration status of the music service provided by the service providing apparatus 130. Substantially, all information on the music play-back status of the music service used by the second terminal 110 may be provided to the service proving apparatus 130.

The communication network 120 may include a wired communication network and a wireless communication network. For example, the wired communication network may be an internet network, such as a cable network or a Public Switched Telephone Network (PSTN), and the wireless communication network may be based on Code Division Multiple Access (CDMA), Wideband CDMA (WCDMA), General System/Standard for Mobile Communication (GSM), Evolved Packet Core (EPC), a Wibro network, etc. The communication network 120 according to an exemplary embodiment is not limited thereto and may be used for a cloud computing network in a cloud computing environment as an access network of a next-generation mobile communication system. For example, in response to the communication network 120 being a wired communication network, an access point in the communication network 120 may connect to an exchange office of a telephone company, and in response to the communication network 120 being a wireless communication network, the access point may process data by connecting to a Serving GPRS Support Node (SGSN) or a Gateway GPRS Support Node (GGSN) operated by a communication carrier or accessing to various relay devices such as Base Station Transmission (BTS), NodeB, e-NodeB, etc.

The communication network 120 may include an access point. The access point may be a small base station, such as a femto base station and/or a pico base station, which is commonly installed in a building. In this case, according to classification for a small base station, the femto base station and the pico base station may be classified by a number of maximum connections of the first terminal 100 and the second terminal 110. The access point includes a local area communication module for performing local area communication, such as Zigbee, Wireless-Fidelity (Wi-Fi), etc., with the first terminal 100 and the second terminal 110. The access point may use TCP/IP or Real-Time Streaming Protocol (RTSP) for wireless communication. In this case, the local area communication may be performed according to various standards such as Wi-Fi, Bluetooth, Zigbee, Infrared Data Association (IrDA), Ultra High Frequency (UHF), Very High Frequency (VHF), Radio Frequency (RF), and Ultra-Wide Band (UWB), etc. Accordingly, the access point may extract a location of a data packet, designate an optimal communication route with respect to the extracted location, and transmit the data packet to a next apparatus, for example, to the first terminal 100 and the second terminal 110 according to the designated communication route. The access point may share several lines in a general network environment. For example, a router, a repeater, and a relay device may be included.

The service providing apparatus 130 may provide a streaming music service according to an exemplary embodiment. That is, the service providing apparatus 130 may provide a music service progress status of users registered in the music service in real time. In this case, the music service progress status may be provided based on contact information of each user. For example, when a user of the second terminal 110 included in the contact information of the first terminal 100 has recently used or is currently using the music service, and a user of the first terminal 100 requests to use the service, the service providing apparatus 130 may show a music service use status of the user of the second terminal 110 in a form of a music list as a first screen.

In this process, the service providing apparatus 130 may provide the first terminal 100 with only updated information and allow the first terminal 100 to process the graphics. However, as a concept of a cloud service, the service providing apparatus 130 may generate all data including graphics and provide the first terminal 100 with the generated data so that the first terminal 100 simply displays the received data on a screen. In addition, as described in detail below, the service providing apparatus 130 may analyze information on the music service progress status of the users and arrange the music lists based on the analysis.

Meanwhile, the service providing apparatus 130 may provide a third party with an open Application Program Interface (API). That is, the service providing apparatus 130 may operate as a platform for a third party. Accordingly, the service providing apparatus 130 may store various types of applications for a music service provided by the third party. Those applications may relate to apparatuses compatible with the first terminal 100 and the second terminal 110 or may be an application which operates with an existing service or content.

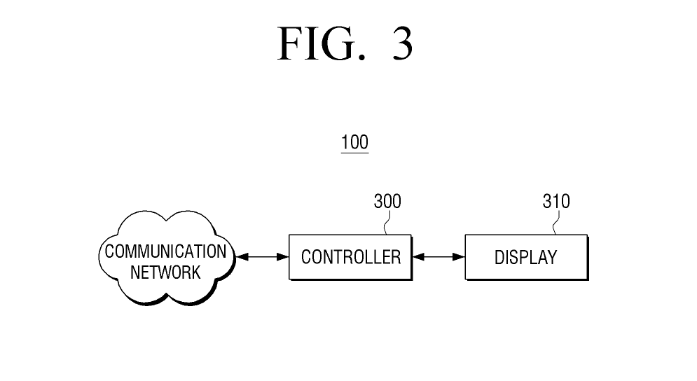

FIG. 3 is a block diagram illustrating an example of a structure of a first terminal illustrated in FIG. 1.

Referring to FIG. 3, the first terminal 100 according to an exemplary embodiment may include a controller 300 and a display 310. The controller 300 may be included in the display 310.

In response to an icon (or menu) displayed on the display 310 being selected by a user in order to use a streaming music service according to an exemplary embodiment, the controller 300 may communicate with the service providing apparatus 130 to provide a music service. For doing this, the controller 300 may control the display 310 according to a user command.

The controller 300 may include an internal memory. For example, in response to receiving a request for a music service from a user, the controller 300 may execute an application related to the music service stored in the memory. In addition, the controller 300 may display a result of the execution on the display 310. For example, in response to receiving a request for a music service from a user, the controller 300 controls the display 310 to display on the first screen a music list based on the contact information and the service registration status and display a button to be formed on the music list to share the music items of the members or contacts. Subsequently, in response to a certain button or icon being selected by the user on each item acting as a music station, the controller 300 controls the display 310 to display a second screen which executes an operation matched with the selected button or icon. For example, in response to the selected button related to sharing a music item being selected by the user, the controller 300 may control the display 310 to display a play-back screen of the shared music item.

Meanwhile, the controller 300 according to an exemplary embodiment may be modified in various ways. That is, the controller 300 may download an application provided by the service providing apparatus 130 at a point of time when a user requests the service, store the downloaded application in a memory, and use the application, rather than storing in the internal memory the application provided by the service providing apparatus 130 when registering in a service. In addition, as a concept of the cloud service, the controller 300 may not be involved in generating graphics. That is, the controller 300 may receive graphic-related video and audio from the service providing apparatus 130 and perform only an operation for simply displaying the graphic-related video and audio on the display 310.

Accordingly, the controller 300 may include an image processor for performing operations such as decoding, scaling, etc. In this case, the controller 300 may include minimum hardware resource for using a cloud music service.

The display 310 may include a touch panel for receiving a command by a user interface on a screen. In response to a touch with respect to a screen of the touch panel, the display 310 may display various screens according to control of the controller 310. In response to execution of an application for using a music service displayed on the screen, the display 310 may display on the first screen a music list, various buttons or icons on the music list, and a notification area for introducing a new music item extracted based on the music items which were played back by the members. In addition, the display 310 may display an execution screen of a shared music item as the second screen, or display various screens such as their music home screen, a friend music home screen, a music room screen in which a group of the members is formed, etc.

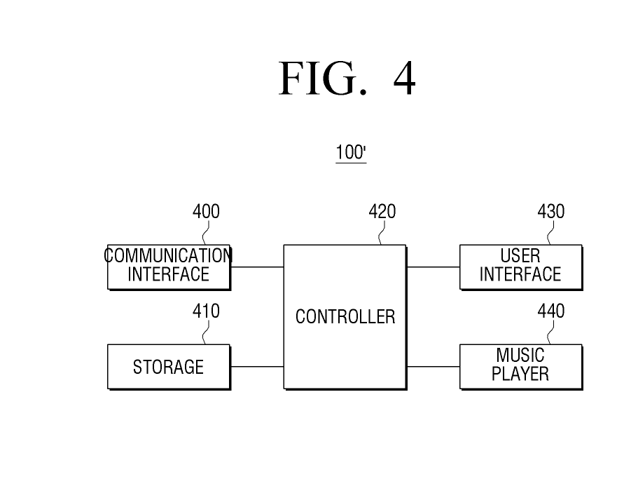

FIG. 4 is a block diagram illustrating an example of another structure of the first terminal illustrated in FIG. 1.

Referring to FIG. 4, a first terminal 100′ according to another exemplary embodiment may include at least one of a communication interface 400, a storage 410, a controller 420, a user interface 430, and a music player 440.

In an exemplary embodiment, a part of components, such as the storage 410, may be omitted or the storage 410 may be integrated in other components such as the controller 420 or the music player 440. In this case, it is described that all of the components are included in the first terminal 100′, for a better understanding of the exemplary embodiments.

The communication interface 400 communicates with the service providing apparatus 130 through the communication network 120. For example, in response to receiving a user request to use a music service, the communication interface 400 provides the service providing apparatus 130 with the request. In addition, the communication interface 400 may receive and process various information for processing the service provided in response to the user request, that is, video data and audio data. For example, the communication interface 400 may perform an operation, such as decoding, scaling, etc. In addition, the communication interface 400 may receive information on the music service progress status that a user of the music service based on the contact information, for example, a friend, used by using the second terminal 100.

The storage 410 stores various bits of information processed by the controller 420 and outputs the stored information in response to receiving a request of the controller 420. In addition, the storage 410 may store the contact information of the first terminal 100. Accordingly, the storage 410 may include a memory for storing volatile information and a memory for storing non-volatile memory.

The controller 420 controls at least one of the communication interface 400, the storage 410, the user interface 430, and the music player 440 in the first terminal 100′. For example, in response to receiving a user request to use a music service through a display constituting the user interface 410, the controller 420 may perform an operation for using the music service by executing the music player 440. In this process, the controller 420 transmits request information to the service providing apparatus 130 via the communication interface 400. Subsequently, the controller 420 may control the display to display the graphic generated in response to the execution of the music player 440 in order to perform a service-related operation which is processed according to an access of the service providing apparatus 130.

The user interface 430 may include a button, a voice recognition unit, and a display. For example, the button may be involved in a power on/off operation. The voice recognition unit may include a microphone and determine a user command by recognizing a user voice using the microphone. The recognized user command may be provided to the controller 420, and thus, various operations may be performed according to the recognized user command. For example, in response to a user command uttered as a voice being related to execution of a music service, the music player 440 may be executed. The display may include a touch panel and provide a user interface according to an operation of the touch panel. The display has been described in detail above, and thus, further description will be omitted.

The music player 440 may store a program for using a music service and execute the program. The music player 440 may also be implemented as hardware. For example, the music player 440 may arrange the music lists according to an intimacy, i.e., a closeness relationship, similarity in taste, and similarity in age of music. Such operation requires a large amount of data processing, and thus, it may be performed by the service providing apparatus 130. However, such operation may also be performed by the first terminal 100′.

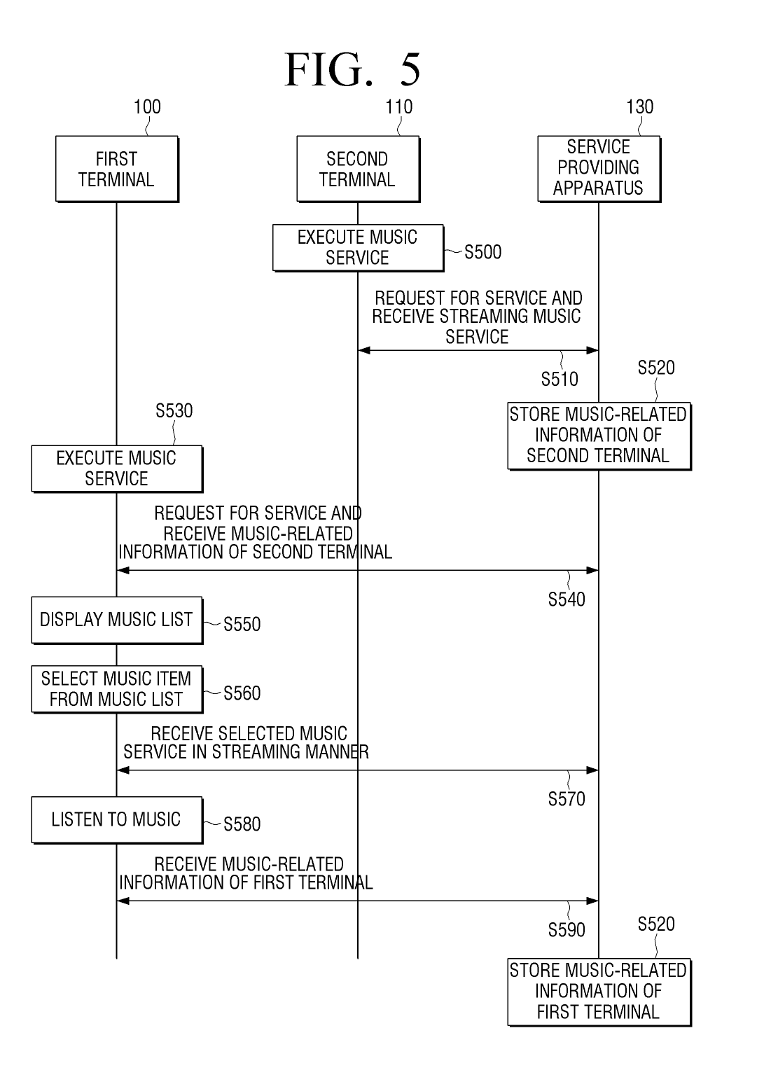

FIG. 5 is a diagram illustrating operations of a music service according to an exemplary embodiment. For example, in response to the first terminal 100 and the second terminal 110 of FIG. 5 having a relation as friends, the first terminal 100 and the second terminal 110 may share information on music-related activities based on the contact information.

As shown in FIG. 5, the second terminal 110 may execute an application for a music service by selecting a particular icon on a screen, connect to the service providing apparatus 130 to use a music service through the application, and share information on the music service with the first terminal 100.

In other words, the second terminal 110 may search and select a music item and listen to the music item in a streaming manner by using a music service (S500, S510). In this process, the second terminal 110 may share contact information-based listening information with the first terminal 100 through the service providing apparatus 130 (S530). That is, by storing information on whether a user is listening to music or on a music item that the user listened to in the service providing apparatus 130, the second terminal 110 may share the information with the first terminal 100.

As described above, even though the user of the second terminal 110, included in the contact information of the first terminal 100, listened to or is listening to music, the first terminal 100 may configure a contact information-based play-back list, i.e., a music list according to information provided by the service providing apparatus 130 and display the music list on the screen in response to receiving a request for the music service from the user of the first terminal (S530, 5540, S550). The service providing apparatus 130 may also configure and provide the music list to the first terminal 100.

In addition, the user of the first terminal 100 may select a desired music item from the contact information-based music list displayed on the screen and listen to the music item that the second terminal 110 is currently listening or listened to in the past in a streaming manner (S560, S570, S580).

In this case, the first terminal 100 may provide the service providing apparatus 130 with contact information based-listening information, and thus, may share the information with the user of the second terminal 110 who stored the contact information of the first terminal 100 (S590, S595).

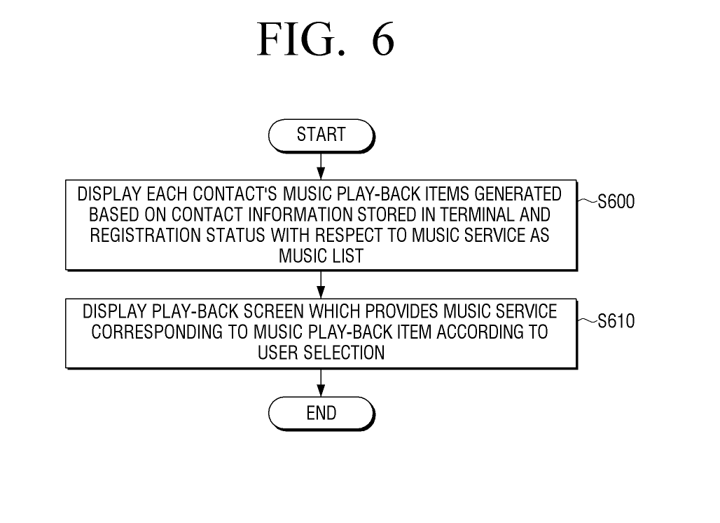

FIG. 6 is a flowchart illustrating an operating process of the first terminal illustrated in FIG. 1.

Referring to FIG. 6, in response to receiving a user request to use the music service, the first terminal 100 according to an exemplary embodiment displays the members' music lists generated based on the contact information stored in the first terminal 100 and the registration status of the music service, and a button which is displayed on the music list to share the music items of the members (S600). The screen belongs to a first screen which is displayed in response to receiving the user request to use the music service.

In the operation of displaying the first screen, in response to the existence of a popular or a newly appeared music item out of the music lists of the members, the first terminal 100 may further display a notification area for introducing the music item.

In addition, in response to a button for sharing a music item being selected on the first screen by the user of the first terminal 100, the first terminal 100 displays a play-back screen of the shared music item (S610). That is, the first terminal 100 may display a screen which plays back a music item that an arbitrary member included in the music lists is currently listening or listened in the past. The screen belongs to a second screen which is displayed according to a user selection on the first screen.

The second screen may include various types of screens. For example, the second screen may include a user's own screen which is displayed in response to selecting a “my room” item in the first screen, a music room screen which is displayed in response to selecting a music room item for forming a music group with the members, a friend home screen which is displayed in response to selecting a name of a member from the music lists. A screen in which the above item lists are displayed in the first screen may belong to the second screen. In this case, the second screens may be a third screen.

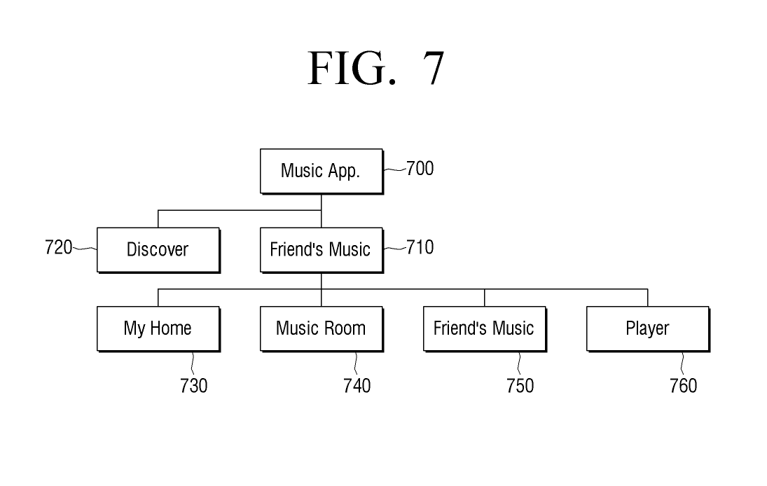

The detailed descriptions related to a screen configuration will be provided below with reference to FIGS. 7 to 18.

FIG. 7 is a diagram illustrating a structure of a screen.

Referring to FIG. 7, the first terminal 100 according to an exemplary embodiment may configure a screen so as to have two or more depths, or an overlay, in a large frame.

For example, in response to a music application 700 displayed on the screen being executed by the user of the first terminal 100, the screen of the first terminal 100 may display a music list screen 710 of the friends. In this case, the screen of the first terminal 100 may display music recommendation for recommending a popular or a new music item in the music list of the members based on the contact information or a notification screen 720 along with a music list screen 710.

In response to the “my room” item being selected by using a menu displayed on the music list screen 710, my music home screen 730 is displayed. In response to a music room item for forming a music group being selected, a music room screen 740 is displayed. In response to a name of a member being selected, a home screen 750 of the member, for example, a home screen of a friend is displayed. In addition, in response to a music-listening service being requested by selecting a particular button on each music item which operates as a music station in the music list, a music play-back screen 760 may be displayed. In response to the music play-back screen 760 being scrolled downwards, the music play-back screen 760 may be placed on a lower part of the screen. As a result, the music list screen 710 may be displayed again. In response to the music play-back screen 760 placed on the lower part of the screen being scrolled upwards, the music play-back screen 760 may be displayed again.

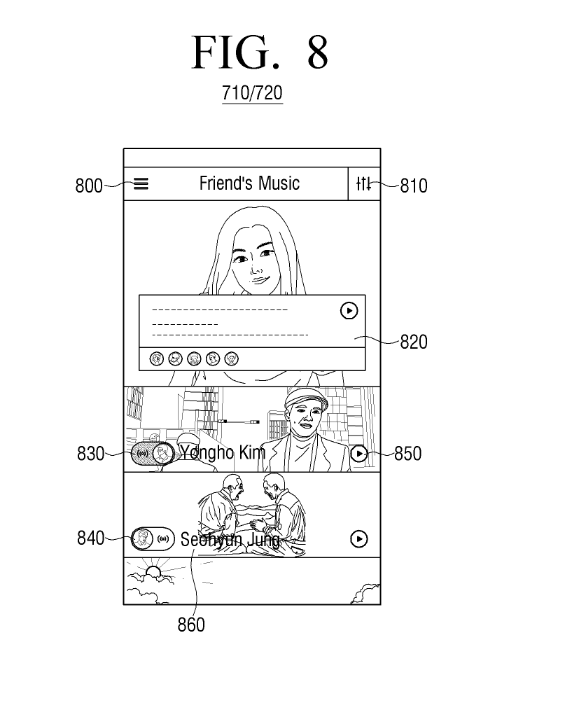

FIG. 8 is a diagram illustrating an example of a music list screen.

Referring to FIG. 8 with references to FIG. 7, the first screen displayed on the screen of the first terminal 100 according to an exemplary embodiment includes at least one of the music list screen 710, the notification screen 720, a first menu 800, and a second menu 810.

In this case, it is described that all of the components are included in the first screen, for better understanding of the exemplary embodiments.

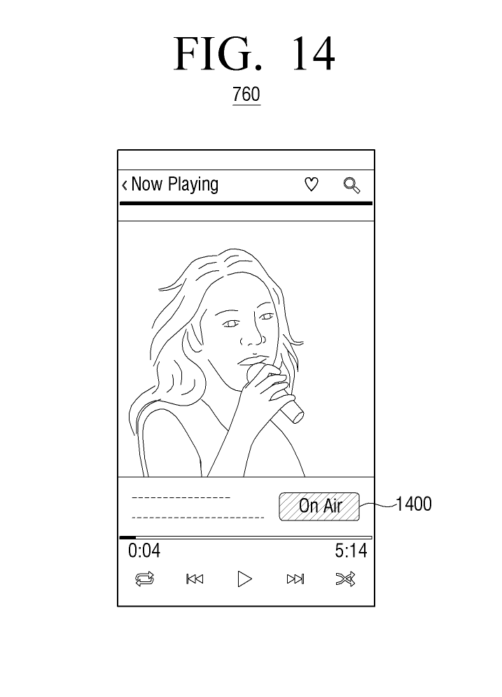

The music list screen 710 is a page list in which a user is able to see other users' music-related activities. Each item which operates as a station may include a first button 830 and 840, a second button 850, and a link area 860. The first button 830 and 840 displays a log-on status 830 and a log-off status 840 of a friend. In response to the log-on status 830, for example, in response to a listening service being available, the listening service may be provided by selecting the button. For example, in response to a casting button being set to be in an on-air status by a friend in a music play-back screen such as that shown in FIG. 14, the user is able to listen to the friend's music item. The second button 850 enables the user to immediately listen to the music item that the friend is currently listening or has listened to recently. Comparing the second button 850 with the first button 830, the second button 850 is different from the first button 830 in that the second button provides a listening service from the beginning of the music item. The link area 860 includes link information for moving to a music home screen in which the friend expresses their musical profile. The link information may be a name of the friend.

The notification screen 720 is an area in which a user displays the most popular song or a newly-appeared song out of the music lists of different friends. The notification screen may be divided into a background screen and a notification window 820. The background screen may display an image related to the song, and the notification window 820 may be overlaid and display additional information related to the song, for example, a song title or a name of a singer.

The music list screen 710, 720 according to an exemplary embodiment may allocate an upper area of the friends' music list, i.e., the notification screen 720, as a space for news contents and display music-related news of the friends. In addition, the user is able to read articles in a manner that mimics turning a page by a swiping operation. In addition, in response to selecting a play button, the user is able to play back the article.

In connection with a background of the notification screen 720, the user is able to select particular music items based on listening history, sharing record, expression of preference of the friends whose music-related information may be brought among the friends in the contact information. Based on the selected music items, the user is able to generate and display different charts for each user, not a public chart. For example, the particular music items may be determined based on the music items which were played back the most among the friends, the music items which were shared the most among the friends, the music items which are frequently listened or shared among the friends, the music items to which the friends express preference, the music items which were popular in the user-preferred genre, the friend's music items which were listened frequently, etc.

The notification window 820 may convert information received hourly into a form of an article of a music chart made by a human by using a template for writing an article. For example, an automated commentary of a football game may belong thereto. In addition, a news-related friend list in the notification window 820 displays a list of friends related to news contents. If a certain friend has a high relevance to the news contents, the friend has a high ranking in the list. The friends related to the news article may be arranged on a lower part of the article, and the priority in the arrangement may vary depending upon the relevance. For example, the friends may be arranged in the order of who listened to the music item that was played back the most.

An operation of generating information related to the notification screen 720 may be performed in the order of listening/sharing→data accumulation→construction of news contents→user access. Such operation may be performed in the first terminal 100 or the service providing apparatus 130. For doing this, the first terminal 100 or the service providing apparatus 130 may include a hardware and/or software component.

The first menu 800 of FIG. 8 shows a list of a “my home” item and a music room item for moving a screen to a “my room” screen or to a music room screen.

In addition, the second menu 810 shows items such as genre-based similarity in musical taste, closeness relationships based on the number of times of sharing, and similarity in age of music through analysis of musical years of a personal library, in order to determine an order of items arranged on the music list screen 710.

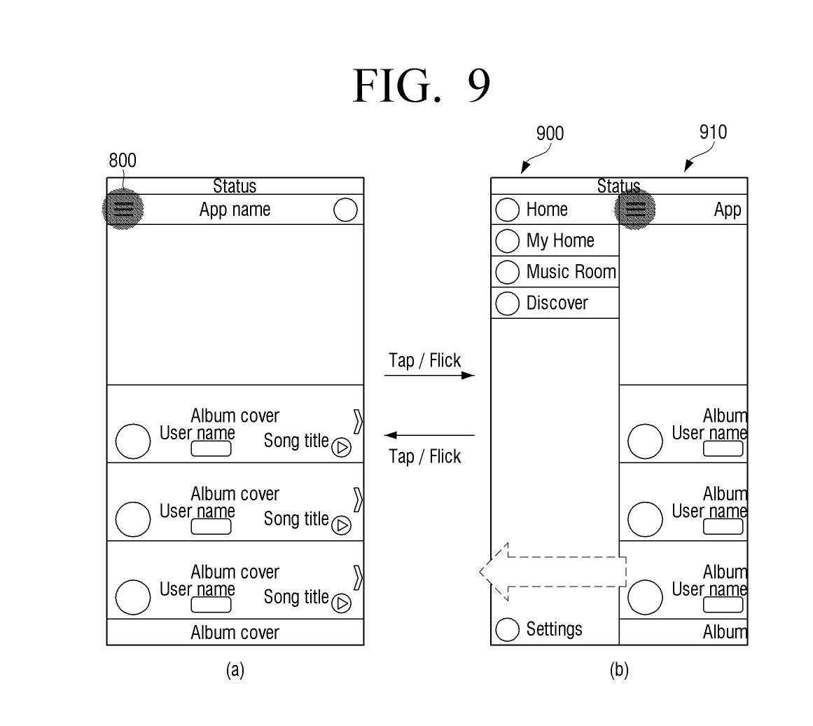

FIG. 9 is a diagram illustrating a screen which is displayed in response to selection of a first menu in a screen of FIG. 8.

Referring to FIG. 9 with reference to FIG. 8, in response to the first menu 800 being selected in a screen illustrated in FIG. 8 or FIG. 9 (a), screen conversion such as that shown in FIG. 9 (b) is performed. That is, as shown in FIG. 9 (b), an item list 900 for moving to various screens is displayed. The item list 900 displays items for converting a screen to various screens, for example, a home item changing to a home, a “my home” item, a music room item, and the like.

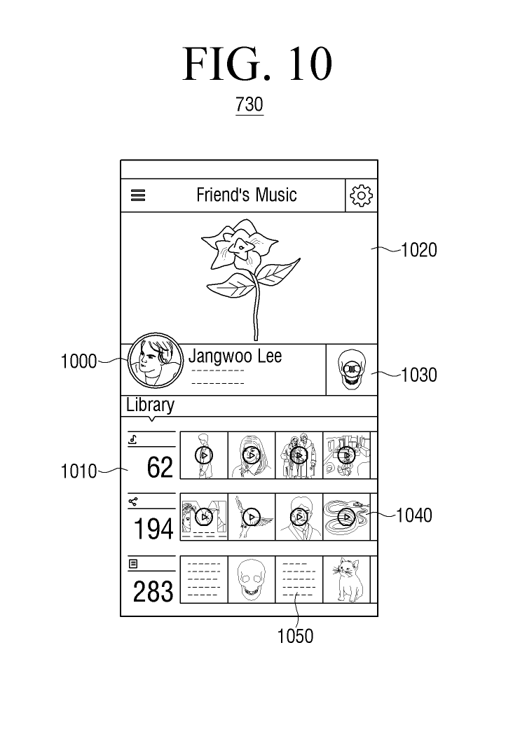

FIG. 10 is a diagram illustrating a “my room” screen which is displayed in response to selection of a “my home” item in the first menu of FIG. 8.

Referring to FIG. 10 with FIGS. 7 and 8, a “my home” screen 730 may include a profile area 1000, a library area 1010, a tag cloud area 1020, a background music (BGM) area 1030, a play-back area 1040, and a music note area 1050.

The profile area 1000 may display a profile picture, a name, comments, the number of songs that the user has, the number of visitors, etc.

The library area 1010 may display a current state of songs related to the user and includes ‘Collected,’ ‘Shared,’ ‘Note,’ and the like. The ‘Collected’ refer to songs taken by other users, the ‘Shared’ refers to songs shared by other users, and the ‘Note’ refers to songs to which other users left a note.

The tag cloud area 1020 is an area for constructing a tag cloud based on the music-listening information. In order to personalize an owner's music home, the tag cloud area 1020 may differently show size, color, location, and color of an artist name and a genre name according to a listening type. For example, in order to show a taste of an owner of a music home, the tag cloud area 1020 may differently show the size, color, and location of texts of the artist and genre in which the user has interests by using the number of times of being listened to the last part by the owner, the number of times of being selected, and the number of times of being searched so that the user's musical taste is shown at a look. The tag cloud may be enlarged depending upon an amount of tags.

In addition, the tag cloud area 1020 may emphasize information about a common feature between users and a distinct feature between the user and other people. The tag cloud may differently apply color, brightness, thickness, and sound of a tag which correspond to common interests and a difference between an owner of the tag cloud and an observer so that the observer is able to recognize the common feature and the distinct feature between a visitor and the owner as soon as the observer enters a page.

Further, the tag cloud area 1020 may provide additional information and additional functions. The tag cloud may locate a small or hidden cloud by using an enlarging operation or a reducing operation and may delete undesired tags through an easy interaction, for example, through a throwing operation after a long tap, i.e. a flicking motion toward an edge of the screen. In addition, the tag cloud may highlight a particular tag in a front side by a touch operation and may provide the additional functions such as playing back music or displaying music-related information.

The BGM area 1030 is an area for displaying a song set by the owner of the home which may be played back as a background music when entering the home.

The play-back area 1040 is an area in which a user is able to play back songs in a library anytime by clinking a cover thereof.

The music note area 1050 is an area in which a user is able to leave a note with respect to a music item, and the music item with the note may be displayed on a blurred cover in a form of a text preview.

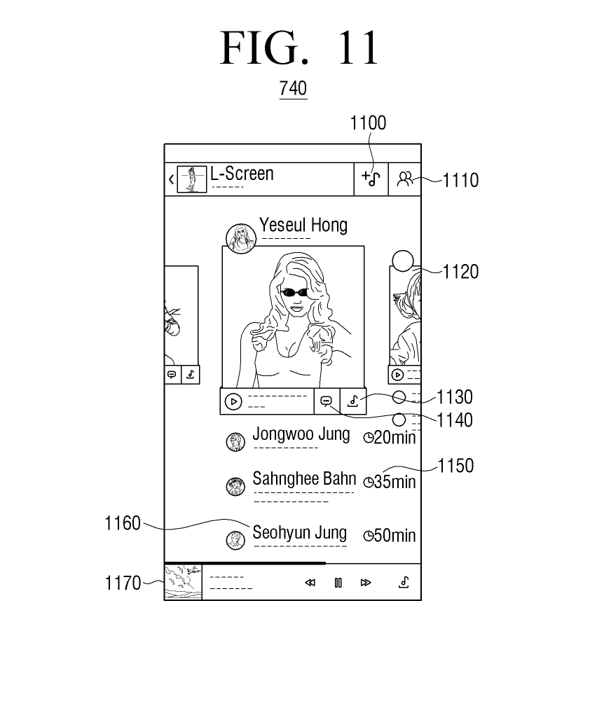

FIG. 11 is a diagram illustrating a music room screen which is displayed in response to a selection of a music room item in the first menu of FIG. 8.

Referring to FIG. 11 with reference to FIGS. 7 and 8, the music room screen 740 includes at least one of a song add icon 1100, a friend list icon 1110, a next song display area 1120, a take icon 1130, a comment icon 1140, a song comment area 1150, a friend link area 1160, and a player area 1170.

The song add icon 1100 opens a song list for adding a “my music” item in a current room. The friend list icon 1100 shows friends which are currently participating. The next song display area 1120 shows a song to be played back in a next turn. The next song display area 1120 registers a current music item in my library. The comment icon 1140 enables a user to leave a comment with respect to a current music item. The song comment area 1150 shows comments related to the currently played song. The friend link area 1160 is a link for moving to a friend's home screen in which the friend's musical profile is expressed or to a particular music screen. The player area 1170 is an independent player area and belongs to an area for managing a play-back list before entering and playing a play-back list of a music room.

The music room screen 740 of FIG. 11 is an area in which users connected by a mobile account or an access list form a musical space and upload their music items. Through the music room screen 740, the users are able to register a series song list in a form of queue, respectively. In addition, the songs and the space of the participated users remain in both a real time status or an off-line status, and thus, the users are able to enter the music room screen and listen to music anytime. In addition, it may be possible to combine other media, such as a picture, video, a text, and the like, with a music item when requesting music and to share the item in a new form. Further, it may be possible to suggest a pop-up with respect to newly added music items, skip to a new music item, and determine an order of playing back the music items without being overlapped. For example, it is possible to play back the music items from the third song, add a new song while the fourth song is played back, or move to a new song according to a user selection. Alternatively, the users may set a play-back order of the music items arbitrarily or randomly.

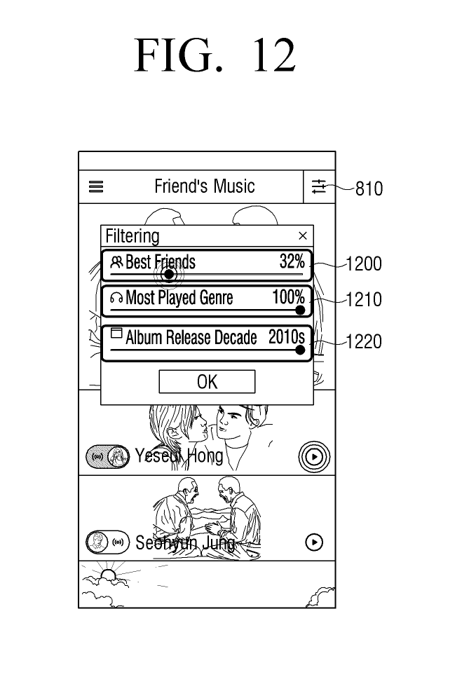

FIG. 12 is a diagram illustrating a screen which is displayed in response to selection of a second menu in the screen of FIG. 8.

Referring to FIG. 12 with reference to FIG. 8, in response to the second menu 810 being selected in the screen of FIG. 8, a screen such as that shown in FIG. 12 may be displayed. The second menu 810 may be called a list sorting menu. The second menu 810 may control the genre-based similarity in musical taste, the closeness relationships based on the number of times of sharing, and the similarity in age of music based on an analysis of musical age of a personal library.

A closeness relationship control bar 1200 illustrated in FIG. 12 may control a priority order of people who interact with each other usually by using sharing of music items, listening to each other's music items, messaging, expression of likability, etc. A taste similarity control bar 1210 may classify music items by genres and may rearrange friends in a descending order of similar listening patterns by genres. A taste degree of each user may be set based on comparison of Euclidean distance. In addition, a musical age similarity control bar 1220 may control a priority order in arrangement in a descending order of similarity in a year of issue of a music item. Music lists to be arranged may be changed according to control of the closeness relationship control bar 1200, the taste similarity control bar 1210, and the music age similarity control bar 1220.

For example, according to an exemplary embodiment, a contact list may be rearranged by using information on a music-listening pattern for each user. In other words, by collecting information on a music item that a user listens to and accumulating interaction information with other users which occurs about the music item, a friend list may be rearranged appropriately.

In connection with the closeness relationships, it is possible to accumulate and use interaction information between two users, that is, the number of times of sharing, the number of messages, the number of times of listening, and the number of times of visits in setting a priority order. That is, the priority order may be set according to Formula 1 as below.

Interaction score of A and B=Sharing 10 times+Messages 4 times+Listening 20 times, and Visits 10 times

=1×10+1×4+1×20+1×10

=44

Interaction score between A and C=1×20+1×10+1×40+1×5

=75 [Formula 1]

Accordingly, priority order of closeness relationship of A in an ascending order=B→C

In connection with the taste similarity, it is possible to normalize a user's listening accumulation values by genre and arrange the values in a descending order of similarity or in another order. The values may be expressed by Formula 2.

$${A}^{′} s taste \text{:} Ballad 30 times + Dance 40 times + Jazz 30 times ⇒ 3 , 4 , 3 ( normalized ) \\ {B}^{′} s taste \text{:} Ballad 20 times + Dance 10 times + Jazz 20 times ⇒ 4 , 2 , 4 ( normalized ) \\ {C}^{′} s taste \text{:} Ballad 10 times + Dance 40 times + Jazz 0 times ⇒ 2 , 8 , 0 ( normalized ) \\ Taste similarity of A and B = … ⋮ = 2.44948974278 \\ ( as the value is smaller , the tastes are more similar ) \\ Taste similarity of A and B = … ⋮ = 5.09901951359 \\ ( Euclidean distance ) \\ ∴ {A}^{′} s priority order of similarity in an ascending order = B -> C \qquad [ Formula 2 ]$$

In addition, in connection with the similarity in age of music, the priority may get higher as an average value and a variation value of the year of issue of music items that a user listened to are similar.

Considering the above, the first terminal 100 or the service providing apparatus 130 of FIG. 1 may perform operations in the order of listening/sharing→data accumulation—arrangement→user access in order to arrange lists. In addition, the first terminal 100 or the service providing apparatus 130 for performing such operations may include software and/or hardware components.

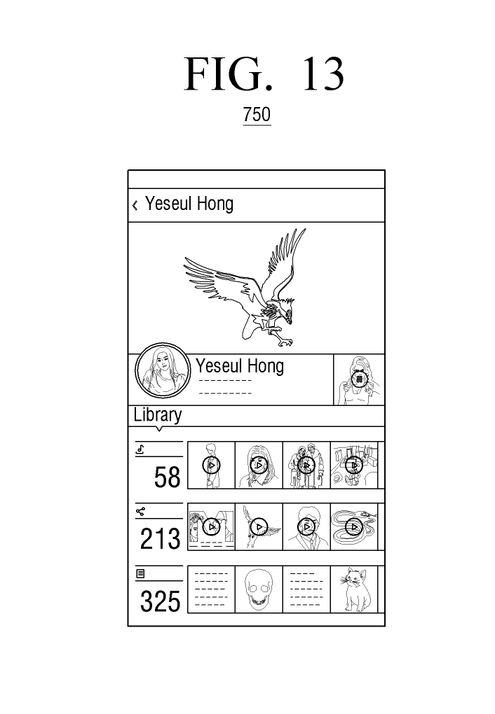

FIG. 13 is a diagram illustrating a friend's home screen which is displayed in response to a selection of a link area of FIG. 8.

The friend's home screen 750 illustrated in FIG. 13 has been described above in connection with the “my home” screen 730 of FIG. 10, and thus, further description will be omitted.

FIG. 14 is a diagram illustrating a play-back screen which is displayed in response to a user music selection.

Referring to FIG. 14 with reference to FIGS. 7 and 8, the play-back screen 760 illustrated in FIG. 14 is a screen related to a song currently being played back by a user through a searching operation, etc. In the play-back screen 760, the user is able to determine whether to make public his/her music listening status. In other words, the user is easily able to determine whether to make public their music listening status by turning on/off the casting button 1400 in the play-back screen 760. In response to the casting button 1400 being turned on to be an On-air status, the first button 830 in the friend's music list screen 710, 720 of FIG. 8 displays a corresponding allowance status. Through such operation, the user is able to enable a friend to listen to his/her music item, for example.

In response to the casting button 1400 being turned on and changed to the on-air status, song information and a play-back status after being changed to the on-air status, for example, a point of time of the play-back is made public to other users registered as a friend of the user who made public their music item and is displayed on a user music list page. In addition, the play-back list after the point of time of the play-back is made public on the user music list page. Further, in response to the song being changed by a public user, a cover page of the user's music list is also changed and shows the change. In response to the casting button 1400 in an off status, song information that was made public last by the user is displayed on the user's music list page and is blurred to display that the listening is unavailable.

As described above, through simple manipulation of the casting button 1400, the user is able to easily make public a listening status and share a music item that the user is currently listening with other users, that is, other users based on the contact information and the service registration status.

Meanwhile, as shown in FIG. 8, the other users are able to listen to the published music item in the on-air status of the first button 830. That is, a user who made public their current music listening status is displayed as being in an on status on the user music list page. Accordingly, in response to the casting button 1400 being toggled by a certain user, the first button 830 of other users is blurred again, and my play-back list is completed to correspond to song information and play-back status information of the user. In response to two users being the users of the same service and having an access authority to the song, entire songs may be provided. In response to only one user being the user of the service and having an access authority to the song, a sample may be played back.

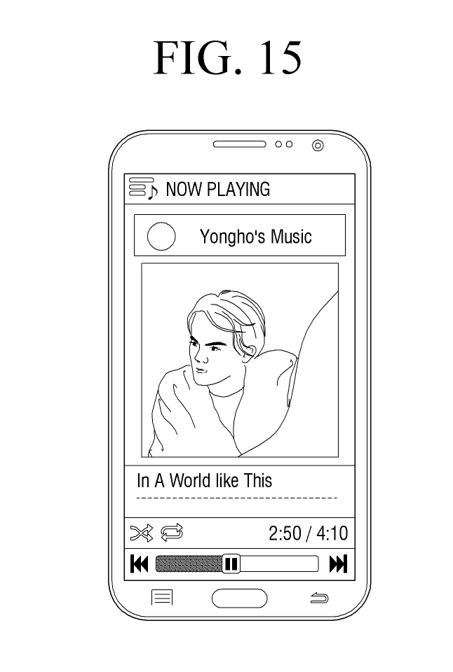

FIG. 15 is a diagram illustrating a play-back screen which is displayed in response to selection of a first button or a second button of FIG. 8.

Referring to FIG. 15 with reference to FIG. 8, in response to the first button 830 or the second button 850 being selected by a user, a play-back screen such as that shown in FIG. 15 may be displayed. Comparing the screen with the play-back screen of FIG. 14, the play-back screen of FIG. 15 might not include the casting button 1400 of FIG. 14. For example, only a user who implements a play-back screen such as that shown in FIG. 14 may have a play-back authority, which may prevent indiscriminate use. In response to a user who has interest in a friend's songs and does not have an access authority to the song, the play-back screen of FIG. 15 may be a screen which plays back only a sample, that is, only a part of the songs, not the entire songs. In other words, a music streaming service is a model that may be used freely among people having a music license. Thus, a user who does not have the license is able to listen to each song for 30 seconds or 1 minute as prescribed by terms of use or the law.

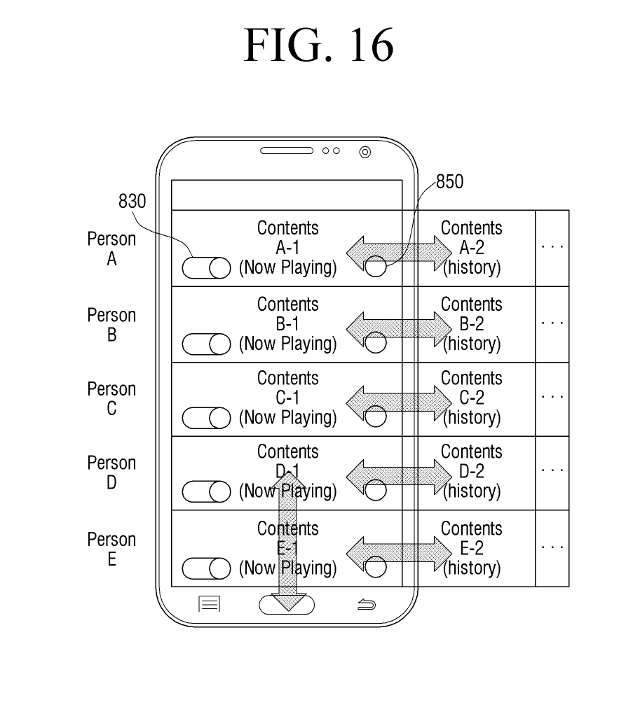

FIG. 16 is a diagram illustrating a user music history.

As shown in FIG. 16, an exemplary embodiment combines an interface of a user's music service and an interface of a play-back application and provides an interface that enables a user to directly access a current music play-back status and a music play-back status in the past of people connected by a social network service. That is, according to an exemplary embodiment, it is possible to share a music item with other users in real time and at an off time based on the contact information.

In FIG. 16, each column, that is, each item includes music lists of each user, and an order of the music lists may be changed to an order of time, an order of frequency, an order of matching degree of the users, etc. A basic order is set to be an order from a currently played music item to a recently played music item, and the music items are arranged according to the order of the songs. However, this is only one example, and a person having ordinary skill in the art will recognize that there are many possible combinations to use.

Each column has a cover art of a song as a background, and the background is updated through mutual information sharing in response to an update of song information.

In response to a user swiping operation on each column, the user is able to look through the songs according to an arranged order. In response to a pre-listening/play-back switch button, that is, the second button 850 being pressed for long, the user is able to listen to the song while the button is pressed.

Vertical scrolling is an interaction for navigating a list in a vertical direction and may be reconstructed by an arrangement option.

A listening switch, that is, the first button 830 is activated when a user of a column logs on to a service online or is connected to a main user by a network, and in response to the first button 830 being turned on, the music items that users are listening may be played back simultaneously. In response to the play-back being stopped by a user, a next song may be played back according to history information of the user.

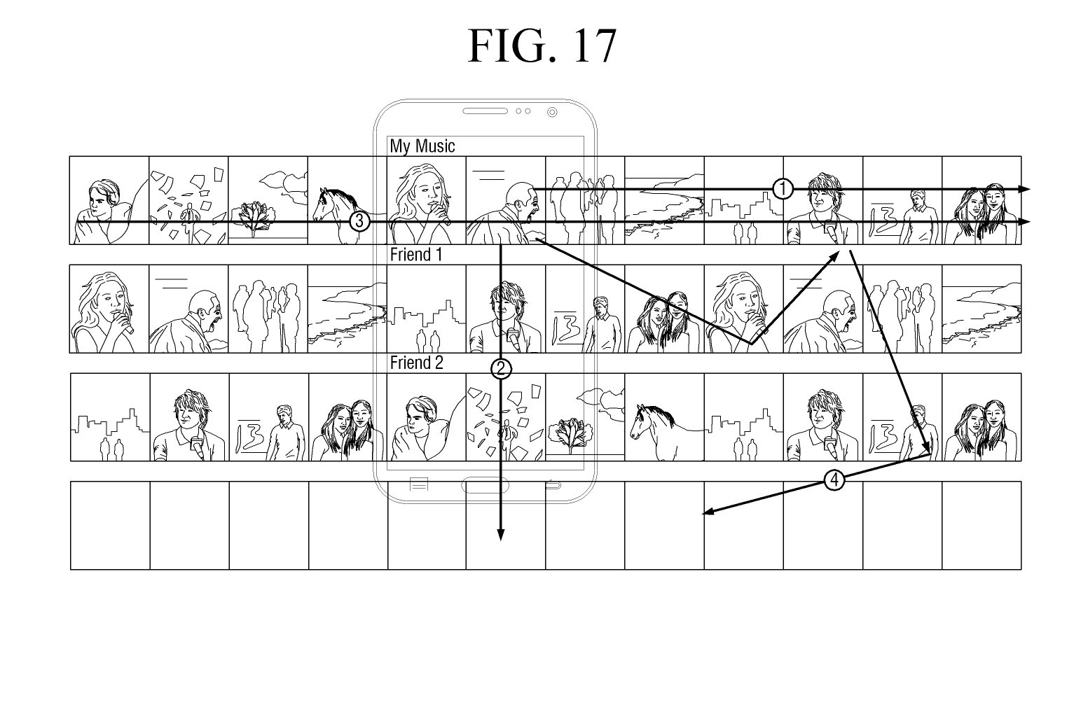

FIG. 17 is a diagram illustrating various play-back options for playing back songs in a music list.

As shown in FIG. 17, the first terminal 100 of FIG. 1 according to an exemplary embodiment may play back friends' music items included in a music list in various ways. That is, FIG. 17 shows a method for consecutively playing back songs, which may be added as a separate item on the first menu 800 of FIG. 8.

For example, according to an exemplary embodiment, in order to play back the friends' songs included in the music list, a user of the first terminal 100 is able to set various methods such as a method of sequentially playing back history songs of each user (0), a method of playing back songs of each user one by one in a disc jockey (DJ) manner (0), a method of repeatedly playing back history songs of a user (0), a method of playing back songs in the list of the entire users in a shuffling manner, etc.

Meanwhile, although it has been described above that entire components constituting the exemplary embodiments of the present disclosure are combined as a single component or operate by being combined with each other, the exemplary embodiments are not limited thereto. That is, unless it goes beyond the purpose of the exemplary embodiments, the components may be selectively combined as one or more components. In addition, each of the components may be implemented as independent hardware. Alternatively, a part or all of the components may be selectively combined and implemented as a computer program having a program module which performs a part or all functions combined in one or a plurality of pieces of hardware. Codes and code segments constituting the computer program may be easily derived by a person having ordinary skill in the art. Such computer program may be read and executed by a non-transitory computer readable recording medium, thereby implementing an exemplary embodiment of the present disclosure.

The non-transitory computer readable recording medium may refer to a medium which may store data semi-permanently. Specifically, the above-described various applications and programs may be stored in a non-transitory computer readable recording medium such as a compact disc (CD), a digital versatile disk (DVD), a hard disk, a Blu-ray disk, a universal serial bus (USB), a memory card, and a read-only memory (ROM), etc., and provided therein.

The foregoing exemplary embodiments are merely exemplary and are not to be construed as limiting the present inventive concept. The present teaching can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A method for displaying a screen of a terminal, the method comprising:
displaying a music list comprising a music play-back item of each of one or more contacts, the music play-back item generated based on contact information of the one or more contacts stored in the terminal and a registration status of the one or more contacts with a music service; and
displaying a play-back screen that provides a music service corresponding to a music play-back item of a contact according to a user selection from among the music play-back item of each of the one or more contacts.

2. The method as claimed in claim 1, wherein the displaying the music list comprises displaying a notification area that provides information on a popular music item or a new music item included in the music list.

3. The method as claimed in claim 1, wherein the displaying the music list comprises displaying a first button for each of the one or more contacts, which shows an on status or an off status of each of the one or more contacts connected online, and in response to a selection of the first button while a contact is in an on status, providing a listening service of shared music items between the user and the contact.

4. The method as claimed in claim 3, wherein the displaying the music list further comprises displaying a second button for each of the one or more contacts, which, when selected, plays back a last music item to which the contact in an off status last listened.

5. The method as claimed in claim 1, wherein the displaying the music list comprises displaying a link area for moving to a music home screen of the contact.

6. The method as claimed in claim 1, wherein the displaying the music list comprises displaying a first menu for setting at least one of a closeness relationship with the contact, a similarity in taste with respect to the music items, and a similarity in age of the music items, to determine a display order of the music list.

7. The method as claimed in claim 6, wherein the displaying the music list further comprises displaying a second menu including a my room menu item for moving to a music home screen of the user and a music room menu item for forming a music group with the contacts.

8. The method as claimed in claim 7, wherein the second menu further comprises a play-back option menu item for setting an option of playing back the music items in the music list of the contacts, and
wherein the play-back option menu item comprises at least one of an option of playing back the music items of each contact in a sequential order, in a reverse sequential manner, or in a shuffling manner; or
at least one of an option of playing back the music items of the entire contacts one by one in a sequential order, in a reverse sequential manner, or in a shuffling manner.

9. The method as claimed in claim 1, wherein the music list is changed according to a predetermined time cycle.

10. A terminal comprising:
a display configured to display a music list comprising a music play-back item of each of one or more contacts, the music play-back item generated based on contact information of the one or more contacts stored in the terminal and a registration status of the one or more contacts with a music service; and
a controller configured to control the display to display a play-back screen that provides a music service corresponding to a music play-back item of a contact according to a user selection from among the music play-back item of each of the one or more contacts.

11. The terminal as claimed in claim 10, wherein the display is further configured to display a notification area that provides information on a popular music item or a new music item included in the music list.

12. The terminal as claimed in claim 10, wherein the display is further configured to display a first button for each of the one or more contacts, which shows an on status or an off status of each of the one or more contacts connected online on the music play-back item of the music list, and in response to selection of the first button while a contact is in an on status, provide a listening service of shared music items between the user and the contact.

13. The terminal as claimed in claim 12, wherein the display is further configured to display a second button for each of the one or more contacts, which, when selected, plays back a last music item to which the contact in an off status last listened.

14. The terminal as claimed in claim 10, wherein the display is further configured to display a first menu for setting at least one of a closeness relationship with the contact, a similarity in taste with respect to the music items, and a similarity in age of the music items, to determine a display order of the music list.

15. A non-transitory computer readable recording medium comprising a program for executing a method for displaying a screen of a terminal, the method comprising:
displaying a music list comprising a music play-back item of each of one or more contacts, the music play-back item generated based on contact information of the one or more contacts stored in the terminal and a registration status of the one or more contacts with a music service; and
displaying a play-back screen that provides a music service corresponding to a music play-back item of a contact according to a user selection from among the music play-back of each of the one or more contacts.

16. The non-transitory computer readable recording medium as claimed in claim 15, wherein the displaying the music list comprises displaying a notification area that provides information on a popular music item or a new music item included in the music list of the [symbol] .

17. A method of sharing music, the method comprising:
displaying a music list on a terminal screen, wherein the music list comprises a first music item associated with a first contact and a second music item associated with a second contact;
displaying a first button for reproducing the first music item and a second button for reproducing the second music item; and
playing one of the first music item and the second music item, in response to a user of the terminal selecting one of the first button and the second button while the one of the first contact and the second contact is in a logged on status.

18. The method of claim 17, further comprising linking to a home page of one of the first contact and the second contact by pressing a link area of one of the first music item and the second music item.

19. The method of claim 17, wherein the playing comprises:
playing music that the one of the first contact and the second contact is currently reproducing if the one of the first contact and the second contact is in a logged on status; and
playing music last listened to by the one of the first contact and the second contact if the one of the first contact and the second contact is in a logged off status.

20. The method of claim 17, further comprising displaying most popular songs of the music list, in a notification area of the screen.
